(19) United States
(12) Patent Application Publication
(10) Pub. No.: US 2012/0187045 A1
(43) Pub. Date: Jul. 26, 2012

(54) METHOD FOR SEPARATING SUBSTANCE MIXTURES BY MEANS OF MULTIPHASE POLYMER FILMS

(75) Inventors: Arno Lange, Bad Durkheim (DE); Hans-Joachim Hähnle, Neustadt (DE); Stefan Spange, Orlamunde (DE); Claudia Staudt, Dusseldorf (DE); Michael Biskupski, Krefeld (DE)

(73) Assignee: BASF SE, Ludwigshafen (DE)

(21) Appl. No.: 13/499,460

(22) PCT Filed: Sep. 27, 2010
(86) PCT No.: PCT/EP10/64254

§ 371 Date: Mar. 30, 2012

(30) Foreign Application Priority Data
Oct. 1, 2009 (EP) 09171969.0

(51) Int. Cl. B01D 61/36; B01D 71/00; B01D 67/00; B01D 53/22

(52) U.S. Cl. 210/640; 95/45; 210/650

(57) ABSTRACT

The present invention relates to a process for separating substance mixtures by means of a nonporous polymer film which has
(a) at least one inorganic or organometallic phase and
(b) at least one organic polymer phase,
   wherein the polymer film is obtainable by polymerizing at least one monomer which has at least one first polymerizable monomer segment A1 comprising at least one metal or semimetal M and at least one second polymerizable organic monomer segment A2 which is connected to the polymerizable monomer segment A1 via a covalent chemical bond, under polymerization conditions under which both the polymerizable monomer segment A1 and the polymerizable organic monomer segment A2 polymerize with breakage of the covalent chemical bond between A1 and A2.

The present invention also relates to the use of the aforementioned polymer films for permeation, gas separation or pervaporation.

The present invention relates to a process for separating substance mixtures by means of a nonporous polymer film which has
(a) at least one inorganic or organometallic phase and
(b) at least one organic polymer phase,
   wherein the polymer film is obtainable by polymerizing at least one monomer which has at least one first polymerizable monomer segment A1 comprising at least one metal or semimetal M and at least one second polymerizable organic monomer segment A2 which is connected to the polymerizable monomer segment A1 via a covalent chemical bond, under polymerization conditions under which both the polymerizable monomer segment A1 and the polymerizable organic monomer segment A2 polymerize with breakage of the covalent chemical bond between A1 and A2.

The present invention also relates to the use of the aforementioned polymer films for permeation, gas separation or pervaporation.

Films composed of composite materials are known per se. For instance, the unpublished application EP 09164339.5 discloses the production of porous film materials proceeding from twin polymers. The resulting porous composite materials find use as separators in electrochemical cells.

Hybrid polymer films as membranes for separating gas mixtures or for pervaporation are known, for example, from WO 03/072232. A disadvantage of these membranes is that an organic polymeric support is first prepared, which is then provided with an inorganic filler. This process is complex and harbors the risk of undesired inhomogeneities. An inherent feature of the process is that at least one phase, generally the inorganic phase, is not continuous, and the domain structures are usually well above 50 nm.

It is thus an object of the present invention to provide a process for separating substance mixtures, which gives good separating properties, especially a high selectivity and a good separating performance, in the case of substance separation by means of permeation. The process should be usable for gas separation and for pervaporation. Compared to known polymer films or membranes, the process should have improved separating properties, good mechanical properties such as a high strength and/or elasticity, good long-term properties, wide usability in different separating processes, and especially an improved selectivity in gas separation and/or pervaporation.

These and further objects are achieved by the process according to the invention.

Accordingly, the present invention relates to a process for separating substance mixtures by means of a nonporous polymer film which has
(a) at least one inorganic or organometallic phase and
(b) at least one organic polymer phase,
   wherein the polymer film is obtainable by polymerizing at least one monomer which has at least one first polymerizable monomer segment A1 comprising at least one metal or semimetal M and at least one second polymerizable organic monomer segment A2 which is connected to the polymerizable monomer segment A1 via a covalent chemical bond, under polymerization conditions under which both the polymerizable monomer segment A1 and the polymerizable organic monomer segment A2 polymerize with breakage of the covalent chemical bond between A1 and A2.

Preferred embodiments are described hereinafter and in the claims. Combinations of preferred embodiments do not leave the scope of the present invention.

A nonporous polymer film is understood to mean a polymer film which has a porosity (proportion by volume of the pores in the total volume) of less than 0.10, especially less than 0.05, more preferably less than 0.02, most preferably less than 0.005. The porosity is determined in the context of the present invention by mercury intrusion measurement to DIN 66133.

Accordingly, a nonporous polymer film is an essentially pore-free polymer film which may have at most defects which cause a minor and negligible porosity. In no way do the polymer films used in accordance with the invention have what is known as open-cell porosity (pores joined to one another).

Such a nonporous polymer film should be strictly distinguished from a porous polymer film, as known, for example, from unpublished application EP 09164339.5. In the latter application, a nonporous polymer film is converted by specific treatment to a porous polymer film, by at least partly removing the organic polymer phase A2 and converting it to pores.

A polymer film is a self-supporting, two-dimensional structure consisting of a polymeric material with a thickness of at most 1000 micrometers, especially at most 500 micrometers, preferably at most 300 micrometers. The thickness of self-supporting polymer films is at least 10 micrometers, especially at least 50 micrometers. Polymeric material is understood to mean inorganic, especially oxidic, organic or mixed inorganic/organic material (composite material).

Substance mixtures shall be understood to mean mixtures of at least two gaseous substances, and mixtures of at least two liquid substances.

The polymer films of the present invention are advantageously used as membranes or in membranes. The polymer film may itself be a membrane (use as a membrane) or be part of a multilayer membrane (use in membranes). Corresponding multilayer membrane structures are known to those skilled in the art. More particularly, the person skilled in the art selects suitable membrane structures depending on the type of separation to be performed. The present polymer films are used as a selectively permeable membrane layer (or membrane), i.e. for substance separation by means of permeation, the polymer films having different permeability with respect to the substances to be separated.

Twin polymerization is the polymerization of at least one monomer which has at least one first polymerizable monomer segment A1 and at least one second polymerizable monomer segment A2 which is connected to the polymerizable monomer segment A1 via a covalent chemical bond, under polymerization conditions under which both the polymerizable monomer segment A1 and the polymerizable organic monomer segment A2 polymerize with breakage of the covalent chemical bond between A1 and A2.

The term “monomer segment” indicates one or more regions of the monomer. A monomer segment comprises especially one or more functional groups of the monomer, i.e. the term “segment” or “region” should be understood in functional terms and does not necessarily indicate a spatially delimited region within the monomer.

The polymer films used in the process according to the invention for separation of substance mixtures are obtainable by twin polymerization. The polymerization leads in the context of the process according to the invention to a composite material in the form of a polymer film, wherein the composite material has at least one inorganic or organometallic phase A1* and at least one organic polymer phase A2*.

The term “inorganic phase” relates to an inorganic, especially oxidic, phase, the term “organometallic phase” indicating the presence of organic groups joined to a metal or semimetal.

The polymerization conditions of a twin polymerization are selected such that monomer segments A1 and A2 polymerize synchronously in the course of polymerization of the monomer, the first monomer segment A1 forming an oxidic polymeric material which comprises the metal or semimetal M, and the second monomer segment simultaneously forming an organic polymer (polymer phase A2*) formed from the second monomer segments. The term “synchronously” does not necessarily mean that the polymerizations of the first and second monomer segments proceed at the same rate. Instead, “synchronously” is understood to mean that the polymerizations of the first and second monomer segments are kinetically coupled and are triggered by the same polymerization conditions, generally cationic polymerization conditions, i.e. proceed simultaneously.

Under the polymerization conditions, there is a partial or complete phase separation into a first inorganic or organometallic phase (i.e. the (semi)metal oxide phase A1*), and a second phase formed by the organic polymer (second polymeric material, polymer phase A2*) formed from the second monomer segments. In this way, a composite material composed of the (semi)metal oxide phase A1* and the polymer phase A2* is obtained.

Owing to the synchronous polymerization, very small phase areas composed of the inorganic or organometallic phase A1* and of the polymer phase A2* form, the dimensions of which are generally in the region of a few nanometers, the phase domains of the phase A1* and of the polymer phase A2* preferably having a co-continuous arrangement. The distances between adjacent phase boundaries, or the distances between the domains of adjacent identical phases, are very small and are on average not more than 10 nm, frequently not more than 5 nm, particularly not more than 2 nm and especially not more than 1 nm. There is no macroscopically visible separation into discontinuous domains of the particular phase.

The hydrocarbon groups which are present in the inorganic or organometallic phase A1* and are bonded to the (semi)metal atoms M result from the at least partial use in the polymerization of those twin monomers, as explained above, which bear at least one hydrocarbon group which is bonded to the (semi)metal atom M of the twin monomer via a carbon atom.

Twin polymerization is known in principle and was described for the first time by S. Spange et al., Angew. Chem. Int. Ed., 46 (2007) 628-632 with reference to the cationic polymerization of tetrafurfuryloxysilane to polyfurfuryl alcohol and silicon dioxide, and with reference to the cationic polymerization of difurfuryloxydimethylsilane to polyfurfuryl alcohol and polydimethylsiloxane. Moreover, WO 2009/083083 describes a twin polymerization of optionally substituted 2,2′-spiro[4H-1,3,2-benzodioxasilin] (referred to hereinafter as, SPISI). Reference is made to the disclosure on this subject in WO 2009/083083.

Monomers preferred for the process according to the invention are those in which the monomer segment A1 comprises at least one metal or semimetal M, which is selected from the metals and semimetals of main group 3 (group 3 according to IUPAC), especially B or Al, metals and semimetals of the 4th main group of the Periodic Table (group 14 according to IUPAC), especially Si, Ge, Sn or Pb, semimetals of the 5th main group of the Periodic Table (group 15 according to IUPAC), especially As, Sb and Bi, metals of the 4th transition group of the Periodic Table, especially Ti, Zr and Hf, and metals of the 5th transition group of the Periodic Table, especially V. The metal or semimetal M of the monomer segment A1 is preferably selected from B, Al, Si, Ti, Zr, Hf, Ge, Sn, Pb, V, As, Sb, Bi and mixtures thereof.

Particularly preferred for the process according to the invention are especially those monomers in which the monomer segment A1 comprises a metal or semimetal M which is selected from metals and semimetals of the 4th main group of the Periodic Table, especially Si, Ge, Sn or Pb, and metals of the 4th transition group of the Periodic Table, especially Ti, Zr and Hf and boron.

Monomers particularly preferred for the process according to the invention are those in which the monomer segment A1 comprises a metal or semimetal which is selected from Si, B and Ti.

Very particularly preferred in the context of the process according to the invention are those monomers in which the monomer segment A1 comprises essentially exclusively silicon at least in some or in the entirety of the monomers. In a very particularly preferred embodiment, at least 90 mol % and especially the entirety of the metals or semimetals M present in the twin monomers are silicon.

In a likewise particularly preferred embodiment, at least 90 mol % and especially the entirety of the metals or semimetals M present in the twin monomers are selected from combinations of silicon with at least one further (semi)metal atom, especially boron or titanium. The molar ratio of silicon to the further (semi)metal atom here is preferably in the range from 10:1 to 1:10 and especially in the range from 1:5 to 5:1.

Advantageously, the polymer films used according to the present invention are obtainable by polymerizing a first monomer M1 and at least one further monomer M2, i.e. the twin polymerization is preferably a twin copolymerization. Twin copolymerization is described in international application PCT/EP2010/054404.

In the context of the preferred copolymerization, the monomers to be polymerized comprise a first monomer M1 and at least one second monomer M2 which differs from the monomer M1 at least in one of the monomer segments A1 and A2 (embodiment 1), or wherein the monomers to be polymerized, as well as the at least one monomer M1 to be polymerized, comprise at least one further, different monomer which has no monomer segment A1 and is copolymerizable with the monomer segment A2 (embodiment 2). Suitable monomers are explained hereinafter.

In the particularly preferred embodiment 1, the monomers to be polymerized comprise a first monomer M1 and at least one second monomer M2 which differs from the monomer M1 at least in one of the monomer segments A1 and A2.

In a preferred configuration of embodiment 1, the monomers M1 and M2 differ in the type of monomer segment A1.

Such a difference may be the type of metal or semimetal in the monomer segment A1: for example, twin monomers in which one monomer (monomer M1) comprises silicon as the semimetal and the second monomer M2 comprises a metal or semimetal selected from a metal or semimetal other than silicon, for example boron or a metal of transition group 4 of the periodic table, such as Ti, Zr or Hf, especially Ti, can be copolymerized with one another.

Such a difference may also be the type of the ligand(s) of the metal or semimetal M in the twin monomers which is not involved in the polymerization of the organic phase. When, for example, the metal or semimetal M, especially silicon, in the monomer segment A1 of the monomer M2 has inorganic or organic ligands which are inert under polymerization conditions and are not eliminated under polymerization conditions, for example by means of carbon- or nitrogen-bonded inert hydrocarbon radicals such as alkyl, cycloalkyl or optionally substituted phenyl, these inert radicals become part of the inorganic or organometallic phase. In the case of copolymerization of such a monomer M2 with a monomer M1 which bears no such ligands on the (semi)metal atom of the monomer segment A1, but instead exclusively ligands which form the polymerizable unit A2 and which are preferably bonded via oxygen, the result is generally an inorganic mixed phase or a mixture of two inorganic or organometallic phases with typically oxidic (or nitridic or sulfidic) constituents which result from the monomer M1, and oxidic, sulfidic, nitridic or organometallic constituents which result from the monomer M2.

When, for example, the (semi)metal atom in the monomer M1 is silicon, boron or titanium which has exclusively oxygen-bonded A2 groups and the (semi)metal atom in the monomer M2 is silicon which, as well as the A2 groups which are preferably bonded via oxygen, also bears inert carbon-bonded ligands, the polymerization forms not only silicon dioxide or titanium dioxide but also polysiloxanes or a silicon dioxide or titanium dioxide modified with siloxane units.

In a further particularly preferred configuration of embodiment 1, the monomers M1 and M2 differ in the type of monomer segment A2. In this way, composite materials modified with regard to the organic polymer phase are obtained. When, for example, the monomers M1 and M2 each have monomer segments A21 and A22 respectively, which are copolymerizable with one another, the twin polymerization forms a copolymer formed from an organic polymer phase A21*/A22*. When the monomer segments A21 and A22 are not copolymerizable with one another, the twin copolymerization forms, in the organic polymer phase, a blend of two different polymers in a very intimate mixture with one another, one polymer being formed essentially from the organic polymer phase A21* and the other polymer essentially from the organic polymer phase A22*.

In embodiment 1, the molar ratio of monomer M1 to the at least one further monomer M2 is generally in the range from 5:95 to 95:5, preferably in the range from 10:90 to 90:10, in particular in the range from 15:85 to 85:15 and especially in the range from 20:80 to 80:20.

In inventive embodiment 2, the monomers to be polymerized comprise, as well as the at least one monomer M1, at least one further monomer M′ (comonomer M′) other than the monomers M1, i.e. a conventional monomer which does not have a monomer segment A1 and is copolymerizable with the monomer segment A2. In this way, the twin polymerization forms a copolymer formed from the organic polymer phase A2* which comprises the comonomer M′ in reacted form. Such a comonomer may, for example, be formaldehyde or a formaldehyde precursor such as paraformaldehyde or trioxane, especially when the monomer segment A2 is an optionally substituted benzyl, furfuryl or thienylmethyl unit.

Preferred monomers M1 and M2 are explained in detail hereinafter.

Preferred monomers can be described by the general formula I:

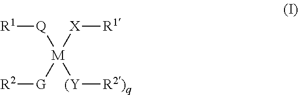

in which
M is a metal or semimetal, preferably a metal or semimetal of main group 3 or 4 or of transition group 4 or 5 of the periodic table, especially B, Al, Si, Ti, Zr, Hf, Ge, Sn, Pb, V, As, Sb or Bi, more preferably Si, Ti, Zr or Sn, even more preferably Si or Ti and especially Si;
R¹, R² may be the same or different and are each an Ar—C(R^{a},R^{b})— radical in which Ar is an aromatic or heteroaromatic ring which optionally has 1 or 2 substituents selected from halogen, CN, C₁-C₆-alkyl, C₁-C₆-alkoxy and phenyl, and R^{a}, R^{b} are each independently hydrogen or methyl or together are an oxygen atom and in particular are both hydrogen, or the R¹Q and R²G radicals are each a radical of the formula A

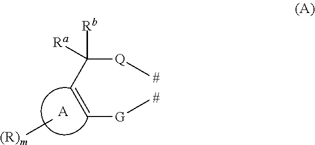

in which A is an aromatic or heteroaromatic ring fused to the double bond, m is 0, 1 or 2, R may be the same or different and is selected from halogen, CN, C₁-C₆-alkyl, C₁-C₆-alkoxy and phenyl, and R^{a}, R^{b} are each as defined above;
G is O, S or NH and especially O;
Q is O, S or NH and especially O;
q according to the valency of M is 0, 1 or 2 and especially 1,
X, Y may be the same or different and are each O, S, NH or a chemical bond and especially oxygen or a chemical bond;
R^{1′}, R^{2′} may be the same or different and are each C₁-C₆-alkyl, C₃-C₆-cycloalkyl, aryl or an Ar′—C(R^{a′},R^{b′})— radical in which Ar′ is as defined for Ar and R^{a′}, R^{b′} are each as defined for R^{a}, R^{b} and in particular are hydrogen, or R^{1′}, R^{2′} together with X and Y are a radical of the formula A, as defined above, and
# are placeholders for the corresponding structural elements of the formula (I).

In the monomers of the formula I, the molecular moieties corresponding to the R¹Q and R²G radicals constitute a polymerizable monomer segment A2. When X and Y are not a chemical bond and R^{1′}X and R^{2′} are not inert radicals such as C₁-C₆-alkyl, C₃-C₆-cycloalkyl or aryl, the R^{1′}X and R^{2′}Y radicals likewise constitute a polymerizable monomer segment A2. In contrast, the metal atom M, optionally together with the Q and Y groups, constitutes the main constituent of the monomer segment A1.

In the context of the invention, an aromatic radical is understood to mean a carbocyclic aromatic hydrocarbon radical such as phenyl or naphthyl.

In the context of the invention, a heteroaromatic radical is understood to mean a heterocyclic aromatic radical which generally has 5 or 6 ring members, where one of the ring members is a heteroatom selected from nitrogen, oxygen and sulfur, and 1 or 2 further ring members may optionally be a nitrogen atom and the remaining ring members are carbon. Examples of heteroaromatic radicals are furyl, thienyl, pyrrolyl, pyrazolyl, imidazolyl, oxazolyl, isoxazolyl, pyridyl or thiazolyl.

In the context of the invention, a fused aromatic radical or ring is understood to mean a carbocyclic aromatic divalent hydrocarbon radical such as o-phenylene (benzo) or 1,2-naphthylene (naphtho).

In the context of the invention, a fused heteroaromatic radical or ring is understood to mean a heterocyclic aromatic radical as defined above, in which two adjacent carbon atoms form the double bond shown in formula A or in the formulae II and III.

In a first preferred embodiment of the monomers of the formula I, the R¹Q and R²G groups together are a radical of the formula A as defined above, especially a radical of the formula Aa:

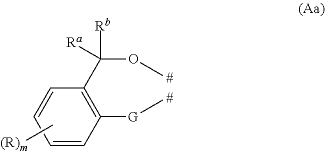

in which #, m, R, R^{a} and R^{b} are each as defined above. In the formulae A and Aa, the variable m is especially 0. When m is 1 or 2, R is especially a methyl or methoxy group. In the formulae A and Aa, R^{a} and R^{b} are especially each hydrogen. In formula A, Q is especially oxygen. In the formulae A and Aa, G is especially oxygen or NH, especially oxygen.

Among the monomers of the first embodiment, particular preference is given especially to those monomers of the formula I in which q=1 and in which the X—R^{1′} and Y—R^{2′} groups together are a radical of the formula A, especially a radical of the formula Aa. Such monomers can be described by the following formulae II and IIa:

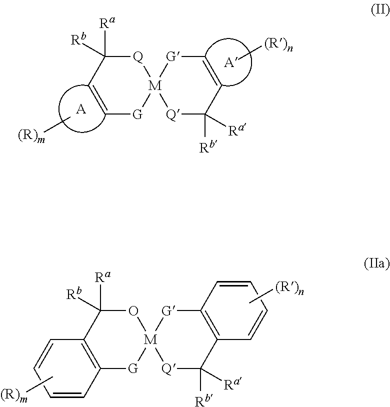

In formula II, the variables are each defined as follows:
M is a metal or semimetal, preferably a metal or semimetal of main group 3 or 4 or of transition group 4 or 5 of the periodic table, especially B, Al, Si, Ti, Zr, Hf, Ge, Sn, Pb, V, As, Sb or Bi, more preferably Si, Ti, Zr or Sn, especially Si;
A, A′ are each independently an aromatic or heteroaromatic ring fused to the double bond;
m, n are each independently 0, 1 or 2, especially 0;
G, G′ are each independently O, S or NH, in particular O or NH and especially O;
Q, Q′ are each independently O, S or NH, in particular O;
R, R′ are each independently selected from halogen, CN, C₁-C₆-alkyl, C₁-C₆-alkoxy and phenyl, and are especially methyl or methoxy;
R^{a}, R^{b}, R^{a′}, R^{b′} are each independently selected from hydrogen and methyl, or R^{a} and R^{b} and/or R^{a′} and R^{b′} in each case together are an oxygen atom; in particular, R^{a}, R^{b}, R^{a′}, R^{b′} are each hydrogen.

In formula IIa, the variables are each defined as follows:
M is a metal or semimetal, preferably a metal or semimetal of main group 3 or 4 or of transition group 4 or 5 of the periodic table, especially B, Al, Si, Ti, Zr, Hf, Ge, Sn, Pb, V, As, Sb or Bi, more preferably Si, Ti, Zr or Sn, especially Si;
m, n are each independently 0, 1 or 2, especially 0;
G, G′ are each independently O, S or NH, in particular O or NH and especially O;
R, R′ are each independently selected from halogen, CN, C₁-C₆-alkyl, C₁-C₆-alkoxy and phenyl, and are especially methyl or methoxy;
R^{a}, R^{b}, R^{a′}, R^{b′} are each independently selected from hydrogen and methyl, or R^{a} and R^{b} and/or R^{a′} and R^{b′} in each case together are an oxygen atom; in particular, R^{a}, R^{b}, R^{a′}, R^{b′} are each hydrogen.

A very particularly preferred embodiment is, as the monomer of the formula II or IIa, 2,2′-spirobis[4H-1,3,2-benzodioxasilin] (compound of the formula IIa where M=Si, m=n=0, G=O, R^{a}=R^{b}=R^{a′}=R^{b′}=hydrogen). Such monomers are known from WO 2009/083083 or can be prepared by the methods described there.

In the monomers II and IIa, the MQQ′ or MOO unit constitutes the polymerizable A1 unit, whereas the remaining parts of the monomer II or IIa, i.e. the groups of the formula A or Aa, minus the Q or Q′ atoms (or minus the oxygen atom in Aa) constitute the polymerizable A2 units.

In a preferred embodiment 1a, a mixture of two or more monomers M1 and M2 is copolymerized, the monomer M1 being a monomer of the formula II or IIa and the further monomer M2 likewise being selected from the monomers of the formulae II and IIa, the monomer M1 differing from the monomer M2 in the type of polymerizable A1 unit, i.e. especially the (semi)metal atom M. More particularly, the (semi)metal atom M in monomer M1 is silicon, and that in monomer M2 is a (semi)metal atom other than silicon, in particular Ti, Zr, Hf or Sn and especially Ti.

In a further preferred embodiment 1b, a mixture of two or more monomers M1 and M2 is copolymerized, the monomer M1 being a monomer of the formula II or IIa and the further monomer M2 being selected from the monomers of the formulae III and IIIa defined below. Here too, the monomer M1 differs from the monomer M2 in the type of polymerizable A1 unit, specifically in that the monomer M2 has ligands which can remain on the metal under polymerization conditions. More particularly, the (semi)metal atom M in the monomer M1 is silicon or titanium, and that in the monomer M2 is silicon.

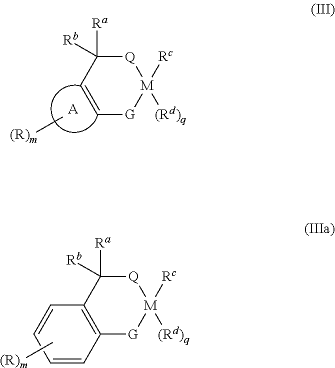

In formula III, the variables are each defined as follows:
M is a metal or semimetal, preferably a metal or semimetal of main group 3 or 4 or of transition group 4 or 5 of the periodic table, especially B, Al, Si, Ti, Zr, Hf, Ge, Sn, Pb, V, As, Sb or Bi, more preferably Si, Ti, Zr or Sn, especially Si;
A is an aromatic or heteroaromatic ring fused to the double bond;
m is 0, 1 or 2, especially 0;
G is O, S or NH, in particular O or NH and especially O;
Q is O, S or NH, in particular O;
R is independently selected from halogen, CN, C₁-C₆-alkyl, C₁-C₆-alkoxy and phenyl, and is especially methyl or methoxy;
R^{a}, R^{b} are each independently selected from hydrogen and methyl, or R^{a} and R^{b} together are an oxygen atom, and are especially both hydrogen;
R^{c,}R^{d} are the same or different and are selected from C₁-C₆-alkyl, C₃-C₆-cycloalkyl and aryl, and are especially each methyl.

In formula IIIa, the variables are each defined as follows:
M is a metal or semimetal, preferably a metal or semimetal of main group 3 or 4 or of transition group 4 or 5 of the periodic table, especially B, Al, Si, Ti, Zr, Hf, Ge, Sn, Pb, V, As, Sb or Bi, more preferably Si, Ti, Zr or Sn, especially Si;
m is 0, 1 or 2, especially 0;
G is O, S or NH, in particular O or NH and especially O;
R is independently selected from halogen, CN, C₁-C₆-alkyl, C₁-C₆-alkoxy and phenyl, and is especially methyl or methoxy;
R^{a}, R^{b} are each independently selected from hydrogen and methyl, or R^{a} and R^{b} together are an oxygen atom, and are especially both hydrogen;
R^{c}, R^{d} are the same or different and are selected from C₁-C₆-alkyl, C₃-C₆-cycloalkyl and aryl, and are especially each methyl.

In a very particularly preferred embodiment, the monomers of the formula III or IIIa used are 2,2-dimethyl-4H-1,3,2-benzodioxasilin (compound of the formula IIIa where M=Si, q=1, m=0, G=O, R^{a}=R^{b}=hydrogen, R^{c}=R^{d}=methyl), 2,2-dimethyl-4H-1,3,2-benzooxazasilin (compound of the formula IIIa where M=Si, q=1, m=0, G=NH, R^{a}=R^{b}=hydrogen, R^{c}=R^{d}=methyl), 2,2-dimethyl-4-oxo-1,3,2-benzodioxasilin (compound of the formula IIIa where M=Si, q=1, m=0, G=O, R^{a}+R^{b}=O, R^{c}=R^{d}=methyl) or 2,2-dimethyl-4-oxo-1,3,2-benzooxazasilin (compound of the formula IIIa where M=Si, q=1, m=0, G=NH, R^{a}+R^{b}=O, R^{c}=R^{d}=methyl). Such monomers are known, for example, from Wieber et al. Journal of Organometallic Chemistry; 1, (1963), 93, 94.

In a further preferred embodiment 1c, a mixture of two or more monomers M1 and M2 is copolymerized, the monomer M1 being a monomer of the formula II or IIa and the further monomer M2 being selected from the monomers of the formula IV, V, Va, VI or VIa defined below. Here, the monomer M1 differs from the monomer M2 in the type of polymerizable A2 unit and optionally in the type of polymerizable A1 unit, especially when the monomers M2 have a (semi)metal atom M other than the (semi)metal atom M of the monomer M1.

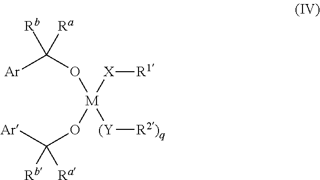

In formula IV, the variables are each defined as follows:
M is a metal or semimetal, preferably a metal or semimetal of main group 3 or 4 or of transition group 4 or 5 of the periodic table, especially B, Al, Si, Ti, Zr, Hf, Ge, Sn, Pb, V, As, Sb or Bi, more preferably Si, Ti, Zr or Sn, especially Si;
Ar, Ar′ are the same or different and are each an aromatic or heteroaromatic ring, especially 2-furyl or phenyl, where the aromatic or heteroaromatic ring optionally has 1 or 2 substituents selected from halogen, CN, C₁-C₆-alkyl, C₁-C₆-alkoxy and phenyl;
R^{a}, R^{b}, R^{a′}, R^{b′} are each independently selected from hydrogen and methyl, or R^{a} and R^{b} and/or R^{a′} and R^{b′} in each case together are an oxygen atom; R^{a}, R^{b}, R^{a′}, R^{b′} are especially each hydrogen;
q according to the valency of M is 0, 1 or 2 and especially 1;
X, Y are the same or different and are each O, S, NH or a chemical bond; and
R^{1′}, R^{2′} are the same or different and are each C₁-C₆-alkyl, C₃-C₆-cycloalkyl, aryl or an Ar′—C(R^{a″},R^{b″})— radical in which Ar″ is as defined for Ar and R′, and R^{a″}, R^{b″} are each as defined for R^{a}, R^{b} or for R^{a′}, R^{b′}, or R^{1′}, R^{2′} together with X and Y are a radical of the formula A, especially a radical of the formula Aa, as defined above.

Among the monomers of the formula IV, preference is given especially to those monomers in which q=0, 1 or 2, especially 1, and the X—R^{1′} and Y—R^{2′} groups are the same or different and are each an Ar″—C(R^{a″},R^{b″})O group, and are preferably each an Ar″—CH₂O group (R^{a}=R^{b}=hydrogen), where Ar″ is as defined above and is especially selected from furyl, thienyl, pyrrolyl and phenyl, where the four rings mentioned are unsubstituted or have one or two substituents selected from halogen, CN, C₁-C₆-alkyl, C₁-C₆-alkoxy and phenyl. Such monomers can be described by the following formulae V and Va:

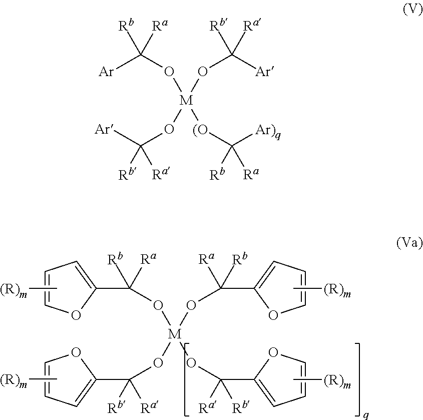

In the formulae V and Va, the variables are each defined as follows:
M is a metal or semimetal, preferably a metal or semimetal of main group 3 or 4 or of transition group 4 or 5 of the periodic table, especially B, Al, Si, Ti, Zr, Hf, Ge, Sn, Pb, V, As, Sb or Bi, more preferably Si, Ti, Zr or Sn, especially Si;
Ar, Ar′ in formula V are the same or different and are each an aromatic or heteroaromatic ring, especially 2-furyl or phenyl, where the aromatic or heteroaromatic ring optionally has 1 or 2 substituents selected from halogen, CN, C₁-C₆-alkyl, C₁-C₆-alkoxy and phenyl;
R^{a}, R^{b}, R^{a′}, R^{′} are each independently selected from hydrogen and methyl, or R^{a} and R^{b} and/or R^{a′} and R^{b′} in each case together are an oxygen atom; R^{a}, R^{b}, R^{a′}, R^{b′} are especially each hydrogen;
q according to the valency of M is 0, 1 or 2 and especially 1.

In formula Va, m is 0, 1 or 2 and especially 0, and R is selected from halogen, CN, C₁-C₆-alkyl, C₁-C₆-alkoxy and phenyl, and especially from methyl and methoxy.

A preferred example of a monomer of the formula V or Va is tetrafurfuryloxysilane (compound of the formula Va where M=Si, q=1, m=0, R^{a}=R^{b}=hydrogen).

Among the monomers of the formula IV, preference is also given to those monomers in which the X—R^{1′} and Y—R^{2′} groups are the same or different and are each selected from C₁-C₆-alkyl, C₃-C₆-cycloalkyl and aryl, for example phenyl, i.e. X and Y are each a chemical bond. Such monomers can be described by the following formulae VI and VIa:

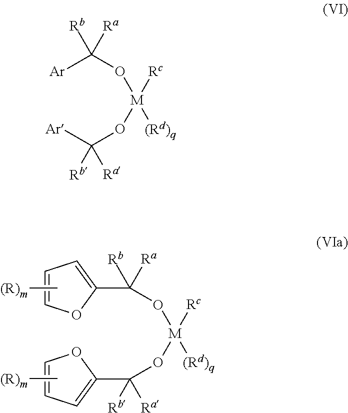

In the formulae VI and VIa, the variables are each defined as follows:
M is a metal or semimetal, preferably a metal or semimetal of main group 3 or 4 or of transition group 4 or 5 of the periodic table, especially B, Al, Si, Ti, Zr, Hf, Ge, Sn, Pb, V, As, Sb or Bi, more preferably Si, Ti, Zr or Sn, especially Si;
Ar, Ar′ in formula VI are the same or different and are each an aromatic or heteroaromatic ring, especially 2-furyl or phenyl, where the aromatic or heteroaromatic ring optionally has 1 or 2 substituents selected from halogen, CN, C₁-C₆-alkyl, C₁-C₆-alkoxy and phenyl;
R^{a}, R^{b}, R^{a′}, R^{b′} are each independently selected from hydrogen and methyl, or R^{a} and R^{b} and/or R^{a′} and R^{b′} in each case together are an oxygen atom; R^{a}, R^{b}, R^{a′}, R^{b′} are especially each hydrogen;
q according to the valency of M is 0, 1 or 2 and especially 1;
R^{c}, R^{d} are the same or different and are each selected from C₁-C₆-alkyl, C₃-C₆-cycloalkyl and aryl, and are especially each methyl.

In formula VIa, m is 0, 1 or 2 and is especially 0, and R is selected from halogen, CN, C₁-C₆-alkyl, C₁-C₆-alkoxy and phenyl and especially from methyl and methoxy.

A preferred example of a monomer of the formula VI or VIa is bis(furfuryloxy)dimethylsilane (compound of the formula VIa where M=Si, q=1, m=0, R^{a}=R^{b}=hydrogen, R^{c}=R^{d}=methyl).

Such monomers of the formulae IV, V, Va, VI and VIa are known from the prior art, for example from the article by Spange et al. cited at the outset and the literature cited therein, or can be prepared in an analogous manner.

In a further preferred embodiment 1d, the monomers M to be polymerized comprise at least one monomer of the general formula IV, especially at least one monomer of the general formula V, and especially at least one monomer of the general formula Va, as defined above.

In a preferred embodiment 1e, a mixture of two or more monomers M1 and M2 is copolymerized, the monomer M1 being a monomer of the formula V or Va and the further monomer M2 likewise being selected from the monomers of the formulae V and Va, the monomer M1 differing from the monomer M2 in the type of polymerizable A1 unit, i.e. the (semi)metal atom M. More particularly, the (semi)metal atom M in the monomer M1 is silicon, and that in the monomer M2 is a (semi)metal atom other than silicon, in particular Ti, Zr, Hf or Sn and especially Ti.

In a further preferred embodiment 1f, a mixture of two or more monomers M1 and M2 is copolymerized, the monomer M1 being a monomer of the formula V or Va and the further monomer M2 being selected from the monomers of the above-defined formulae VI and VIa. Here too, the monomer M1 differs from the monomer M2 in the type of polymerizable A1 unit, specifically in that the monomer M2 has ligands which can remain on the metal under polymerization conditions. More particularly, the (semi)metal atom M in the monomer M1 is silicon or titanium, and that in the monomer M2 is silicon.

It has generally been found to be advantageous, in the context of the twin copolymerization according to embodiment 1, to use those monomers M1 in which the metal or semimetal M does not have a chemical bond to a carbon atom, in combination with monomers M2 in which the metal or semimetal M does have a chemical bond to a carbon atom. For this reason, especially embodiment 1b is preferred. When monomers M1 in which the metal or semimetal M does not have a chemical bond to a carbon atom are combined with monomers M2 in which the metal or semimetal M does have a chemical bond to a carbon atom, the monomers M1 and M2 are preferably used in a molar ratio of M1 to M2 of 80:20 to 20:80, especially of 70:30 to 30:70 and more preferably of 60:40 to 40:60.

In a preferred configuration of inventive embodiment 2, the monomers to be polymerized comprise at least one monomer M which is selected from the monomers of the formula I and at least one further monomer M′ (comonomer M′) which is different than the monomers of the formula I and is copolymerizable with the monomer segment A2 in formula I. Such a comonomer may, for example, be formaldehyde or a formaldehyde precursor such as paraformaldehyde or trioxane.

In a particularly preferred configuration of inventive embodiment 2, the monomers to be polymerized comprise at least one monomer M which is selected from the monomers of the formula II and especially from the monomers of the formula IIa, and at least one further, conventional monomer M′ (comonomer M′) which is different than the monomers of the formula II or IIa and is copolymerizable with the monomer segment A2 in formula II or IIa. Such a comonomer may, for example, be formaldehyde or a formaldehyde precursor such as paraformaldehyde or trioxane.

In a further particularly preferred configuration of inventive embodiment 2, the monomers to be polymerized comprise at least one monomer M which is selected from the monomers of the formula V and especially from the monomers of the formula Va and at least one further, conventional monomer M′ (comonomer M′) which is different than the monomers of the formula V or Va and is copolymerizable with the monomer segment A2 in formula II or IIa. Such a comonomer may, for example, be formaldehyde or a formaldehyde precursor such as paraformaldehyde or trioxane.

The polymerization or copolymerization of the monomers used in the context of the present invention, especially of the monomers of the above-defined general formulae I, II, IIa, III, IIIa, IV, V, Va, VI and VIa can be effected in analogy to the methods described in the prior art.

The preferred initiation of the twin (co)polymerization is effected by an initiator I. Useful initiators I are especially those compounds which initiate a cationic polymerization. Preference is given to Brønsted acids and Lewis acids. The expression “polymerization in the presence of an initiator I” thus relates to the initiation and/or catalysis of the polymerization, preferably by the aforementioned compounds.

Preferred Brønsted acids are organic carboxylic acids, especially trifluoroacetic acid or lactic acid, and organic sulfonic acids such as methanesulfonic acid, trifluoromethanesulfonic acid or toluenesulfonic acid. Preferred inorganic Brønsted acids are HCl, H₂SO₄ and HClO₄. Preferred Lewis acids are BF₃, BCl₃, SnCl₄, TiCl₄, and AlCl₃. The use of Lewis acids in complex-bound form or dissolved in ionic liquids is also possible. The initiator I is typically used in an amount of 0.1 to 10% by weight, preferably of 0.5 to 5% by weight, based on the sum of all monomers.

In the context of the present invention, the polymer films can in principle be produced by different methods.

The production of the polymer films used in accordance with the invention advantageously comprises at least the following steps, (a), (d) and (e):
(a) providing the monomers M1 and optionally M2, an initiator I and optionally a solvent (L), each as defined above;
(d) applying a mixture of the substances provided in step (a), in unconverted or in previously converted or partly converted form, to a surface; and
(e) converting the mixture as per step (d) to a membrane.

Suitable monomers M1 and M2 and initiators I were detailed above. The mixture can be applied in step (d) in such a way that the monomers are applied in a monomeric state, i.e. at first unreacted. Alternatively, the monomers can be applied in a prepolymerized or partly polymerized state (as so-called prepolymers). One such embodiment is explained further below.

The polymerization can be performed in bulk or preferably in an inert diluent. When an inert diluent is used, a multitude of solvents known to those skilled in the art are possible. Inert diluents are referred to as solvents (L) in the context of the present invention. This does not mean that the resulting mixtures are true solutions.

In principle, suitable solvents preferably have at least the following properties:
the solvents (L) are not reactive toward the monomers;
the solvents (L) dissolve the monomers and/or prepolymers;
the solvents (L) are sufficiently volatile, such that they can be removed from the films
the solvents (L) have a viscosity which enables the mixture to be applied.

Suitable solvents (L) are known per se to those skilled in the art. Suitable solvents are, for example, halogenated hydrocarbons such as dichloromethane, trichloromethane, dichloroethene, or hydrocarbons such as toluene, xylene or hexane, and mixtures thereof. Preferred solvents are especially cyclic ethers, especially tetrahydrofuran (THF), and ketones, for example acetone, diethyl ketone, methyl ethyl ketone, methyl isobutyl ketone, methyl n-butyl ketone, ethyl isopropyl ketone, 2-acetylfuran, 2-methoxy-4-methylpentan-2-one, cyclohexanone and acetophenone, particular preference being given to acetone and THF.

The reaction of the monomers M1 and optionally M2 may in principle vary within a wide range and is effected preferably at a temperature of 0° C. to 150° C., more preferably of 20° C. to 120° C., especially of 40° C. to 100° C., most preferably of 70° C. to 90° C.

Preference is given to performing the polymerization of the monomers of the formula I in the substantial absence of water, i.e. the concentration of water at the start of the polymerization is less than 0.1% by weight. Accordingly, preferred monomers of the formula I are those monomers which do not eliminate water under the polymerization conditions. These include especially the monomers of the formulae II, IIa, III and IIIa.

When a prepolymer is first prepared (step (b)), as described below, it is likewise preferably prepared within the range of the temperatures stated above.

The mixing of the monomers M1 and optionally M2 and of the initiator (I) can, just like the mixing of the aforementioned compounds or of the prepolymer resulting therefrom with the solvent (L), be effected by mixing methods known to those skilled in the art, especially by stirring.

The application of the mixture to a surface according to step (d) is likewise effected by methods of application known to those skilled in the art, for example pouring, knife coating or spin coating.

Further reaction of the monomers or reaction of the resulting prepolymer on a surface results in a polymer film. The thickness and size of the polymer film can be adjusted by the person skilled in the art. The thickness is typically 1 to 1000 micrometers, especially from 10 to 500 micrometers, preferably from 50 to 300 micrometers.

In a preferred embodiment, a process for producing the membranes used in accordance with the invention comprises the following steps in the sequence a-b-c-d-e:
(a) providing the monomers M1 and optionally M2, an initiator I and optionally a solvent (L), each as defined above;
(b) reacting the monomers M1 and optionally M2 in the presence of the initiator I and optionally of the solvent (L) to give a prepolymer;
(c) mixing the resulting prepolymer with a solvent (L*);
(d) applying the mixture from step (d) to a surface; and
(e) converting the prepolymer to a polymer film.

The performance of steps (b) and (c) enables control of the viscosity at the time of application to the surface and, as a result, advantageous properties of the resulting polymer film. When a prepolymer is used directly, the process according to the invention comprises the aforementioned steps c-d-e.

When step (b) is performed in the presence of a solvent (L), the solvent L* is preferably a solvent miscible with the solvent L, preferably the same solvent.

The amount of the solvent (L*) in the context of step (c) may vary. However, it should be ensured that the viscosity of the resulting solution is not too high at the time of application to a surface (step (d)). The person skilled in the art determines suitable combinations by suitable preliminary tests.

In the context of step (c), the solvent (L*) is preferably added in a weight ratio of the sum of the parts by weight of the solvents L and L* relative to the weight of the twin monomers M1 and M2 of 1:1 to 50:1, preferably of 2:1 to 30:1, especially of 3:1 to 15:1, more preferably of 4:1 to 10:1, most preferably of 5:1 to 8:1.

The reaction of the monomers and/or the formation of the polymer films may be followed by purification steps and optionally drying steps.

Aging steps may additionally follow. Aging steps are preferably performed at a temperature of 60 to 300° C., especially 100 to 250° C. The aging lasts typically for from 1 to 1000 minutes, especially from 5 to 60 minutes. The aging can be performed especially in the presence of an atmosphere which is inert toward the polymer film (inert gas atmosphere), especially under nitrogen or noble gases. The aging of the polymer film may have a favorable effect on the selectivity, especially toward aliphatic compounds on the one hand and aromatic compounds on the other hand.

It is additionally particularly preferred, after obtaining the polymer films, to treat them with a reactive organic compound (referred to hereinafter as modifier). The modifier is a compound which is reactive toward phenolic groups. Without wishing to impose any restriction, the idea is that treatment with the modifier converts phenolic hydroxyl groups at the surface of the membrane and thus stabilizes it.

Useful modifiers include modifiers known to those skilled in the art, for example reactive derivatives of organic acids such as acetic anhydride or benzoyl chloride, or especially organosilanes. The modifiers used may preferably be organosilanes with halogen or alkoxyl groups. Preferred organosilanes with halogen groups are especially trialkylchlorosilane, more preferably trimethylchlorosilane. Preferred organosilanes with alkoxyl groups are trioctyltrimethoxysilane, octyltriethoxysilane, 3-methacryloyloxypropyltrimethoxysilane, 3-methacryloyloxypropyltriethoxysilane, hexadecyltrimethoxysilane, hexadecyltriethoxysilane, dimethylpolysiloxane, glycidyloxypropyltrimethoxysilane, glycidyloxypropyltriethoxysilane, nonafluorohexyltrimethoxysilane, tridecafluorooctyltrimethoxysilane, tridecafluorooctyltriethoxysilane, aminopropyltriethoxysilane. Also usable with preference is hexamethyldisilazane.

The polymer films thus produced can be used advantageously in the process according to the invention.

The nanocomposite material obtainable by the process according to the invention, in the form of a polymer film, has at least one inorganic or organometallic polymer phase which results from the polymerization of the monomer segment A1, and at least one organic polymer phase which results from the polymerization of the monomer segment A2. The dimensions of the phase domains in the composite material thus obtained are in the region of a few nanometers. In addition, the phase domains of the inorganic or organometallic phase and the phase domains of the organic phase have a co-continuous arrangement, i.e. both the organic phase and the inorganic or organometallic phase penetrate one another and form essentially no discontinuous regions. The distances between adjacent phase boundaries, or the distances between the domains of adjacent identical phases, are exceptionally small and are on average not more than 10 nm, preferably not more than 5 nm and especially not more than 2 nm. No macroscopically visible separation into discontinuous domains of the particular phase occurs.

The distance between adjacent identical phases is understood to mean, for example, the distance between two domains of the inorganic or organometallic phase which are separated from one another by a domain of the organic polymer phase, or the distance between two domains of the organic polymer phase which are separated from one another by a domain of the inorganic or organometallic phase. The mean distance between the domains of adjacent identical phases can be determined by means of combined small angle X-ray scattering (SAXS) via the scatter vector q (measurement in transmission at 20° C., monochromatized CuK_{α} radiation, 2D detector (image plate), slit collimation).

With regard to the terms “continuous phase domains”, “discontinuous phase domains” and “co-continuous phase domains”, reference is also made to W. J. Work et al.: Definitions of Terms Related to Polymer Blends, Composites and Multiphase Polymeric Materials, (IUPAC Recommendations 2004), Pure Appl. Chem., 76 (2004), p. 1985-2007, especially p. 2003. According to this, a co-continuous arrangement of a two-component mixture is understood to mean a phase-separated arrangement of the two phases, in which within one domain of the particular phase a continuous path through either phase domain may be drawn to all phase domain boundaries without crossing any phase domain boundary.

In the inventive nanocomposite materials, the regions in which the organic phase and the inorganic or organometallic phase form essentially co-continuous phase domains amount to at least 80% by volume, especially 90% by volume, of the nanocomposite materials, as can be determined by combined use of TEM and SAXS.

The thickness of the polymer films is guided by the desired application. The thickness of the film material will generally not exceed 500 μm, particularly 300 μm and especially 100 μm (mean). In general, the film material will have a thickness of at least 5 μm, especially at least 10 μm.

The nonporous polymer films obtainable as detailed above can be used in accordance with the invention for permeation, gas separation or pervaporation.

Permeation refers to substance separation by means of a membrane, the driving force being a concentration or pressure gradient, and the membrane having at least partially selective permeability with respect to the substances to be separated. Preference is given to the separation of gases (gas separation) and the separation of liquids (pervaporation).

The polymer films used in accordance with the invention have selective permeability with respect to gases, especially with respect to nitrogen on the one hand and oxygen on the other hand. The polymer films used in accordance with the invention also have selective permeability with respect to aliphatic hydrocarbons on the one hand and aromatic hydrocarbons on the other hand.

### EXAMPLES

### A. Preparation of the Monomers

### Example 1

### 2,2′-Spirobis[4H-1,3,2-benzodioxasilin] (BIS)

135.77 g of salicyl alcohol (1.0937 mol) were dissolved in anhydrous toluene at 85° C. Subsequently, 83.24 g (0.5469 mol) of tetramethoxysilane (TMOS) were slowly added dropwise, and, after addition of one third of the TMOS, 0.3 ml of tetra-n-butylammonium fluoride (1 M in THF) was injected all at once. The mixture was stirred at 85° C. for 1 h, and then the methanol/toluene azeotrope was distilled off (63.7° C.). The residual toluene was removed on a rotary evaporator. The product was dissolved out of the reaction mixture thus obtained with n-hexane at ≈70° C. After cooling to 20° C., the clear solution was decanted off. After removing the n-hexane, the title compound remained as a white solid. The product can be purified to free it of further impurities by dissolving in toluene and reprecipitating with n-hexane.

¹H NMR 400 MHz, CDCl₃, 25° C., TMS) 67 [ppm]=5.21 (m, 4H,CH2), 6.97-7.05 (m, 6H), 7.21-7.27 (M, 2H).

¹³C NMR (100 MHz, CDCl₃, 25° C., TMS): 67 [ppm]=66.3 (CH₂), 119.3, 122.3, 125.2, 125.7, 129.1, 152.4.

²⁹Si CP-MAS (79.5 MHz): 67 [ppm]=−78.4

### Example 2

### 2,2-Dimethyl-[4H-1,3,2-benzodioxasilin] was prepared according to Wieber et al. Journal of Organometallic Chemistry; 1, (1963), 93, 94.

### B. Production of the Polymer Films

All solvents were used in the anhydrous state. Self-supporting films of the hybrid material were produced in an apparatus in which a metal plate of diameter somewhat more than 6 cm was mounted in a desiccator with temperature control in the interior of a heating cabinet and under argon (5.0). The metal plate had a depth of 5 mm with a diameter of 6 cm and was polished.

### Example 3

### (M1/M2=50/50; Acetone)

2.2 mmol of 2,2′-spirobi-[4H-1,3,2-benzodioxasilin] and 2.2 mmol of 2,2-dimethyl-4H-1,3,2-benzodioxasilin were introduced into a flask under inert gas. The mixture was heated until everything had melted. Then 5 mg of lactic acid were added and the mixture was kept at a temperature of 85° C. for 30 minutes. Subsequently, 8 ml of acetone at a temperature of 20° C. were added to the prepolymer with intensive stirring until a homogeneous solution was present. Then the flask contents were added to the apparatus described above and polymerized to completion at 85° C. for 4 h.

A clear, transparent elastic membrane was obtained, which was removable without residue from the metal plate.

### Example 4

### (M1/M2=60/40; Acetone)

Analogously to example 3, a membrane was produced from 1.83 mmol of 2,2′-spirobi-[4H-1,3,2-benzodioxasilin] and 2.77 mmol of 2,2-dimethyl-4H-1,3,2-benzodioxasilin.

### Example 5

### (M1/M2=50/50; THF)

Analogously to example 3, a membrane was produced from 2.2 mmol of 2,2′-spirobi-[4H-1,3,2-benzodioxasilin] and 2.2 mmol of 2,2-dimethyl-4H-1,3,2-benzodioxasilin, except that the acetone solvent was replaced by THF.

### Example 6

### (M1/M2=60/40; THF)

Analogously to example 3, a membrane was produced from 1.83 mmol of 2,2′-spirobi-[4H-1,3,2-benzodioxasilin] and 2.77 mmol of 2,2-dimethyl-4H-1,3,2-benzodioxasilin, except that the acetone solvent was replaced by THF.

### Example 7

### (M1/M2=50/50; No Solvent)

2.2 mmol of 2,2′-spirobi-[4H-1,3,2-benzodioxasilin] and 2.2 mmol of 2,2-dimethyl-4H-1,3,2-benzodioxasilin were introduced into a flask under inert gas. The mixture was heated until everything had melted. Then it was homogenized with 5 mg of lactic acid and the flask contents were introduced into the above-described apparatus and polymerized at 85° C. for 4 h.

### Example 8

### (M1/M2=60/40; No Solvent)

Analogously to example 7, a membrane was produced from 1.83 mmol of 2,2′-spirobi-[4H-1,3,2-benzodioxasilin] and 2.77 mmol of 2,2-dimethyl-4H-1,3,2-benzodioxasilin.

The transparent, elastic nonporous polymer films exhibited, after a period of 30 days, significant aging phenomena which became perceptible under light in a brown discoloration of the polymer film.

### Properties of the Membranes: Pervaporation

Sorption studies with solvents were conducted on the polymer films obtained according to examples 4, 6 and 8. Both unaged samples (4-u, 6-u and 8-u) and membrane samples which had been aged at 200° C. for 20 min (4-a, 6-a and 8-a) were studied. For the sorption studies, the membrane samples were preweighed and then placed into closable glass vessels with the appropriate solvent at room temperature. At intervals of approx. 1-2 hours, the samples were taken out of the solvent and their properties were studied. The samples were gently dabbed dry and then weighed in order to determine the change in weight in % by weight.

Protic and aromatic solvents, for example H₂O, ethanol and toluene, exhibited high affinities for the hybrid material. It has been found that the dissolution behavior of the hybrid material membrane with respect to these solvents could be eliminated by the aging. The aged polymer films, for example in the case of toluene, registered an increase in weight of only approx. 10% by weight, whereas 19.5% by weight was leached out in the case of the unaged polymer films.

Aged and unaged polymer films exhibited comparable swelling resistance with respect to aliphatic solvents, for example cyclohexane and n-dodecane. On the basis of these results, the polymer films according to the present invention can be used advantageously as organophilic membranes for separation of aliphatic/aromatic mixtures.

1-19. (canceled)

20. A process which comprises separating substance mixtures by means of a nonporous polymer film which has
(a) at least one inorganic or organometallic phase and
(b) at least one organic polymer phase,
wherein the polymer film is obtainable by polymerizing at least one monomer which has at least one first polymerizable monomer segment A1 comprising at least one metal or semimetal M and at least one second polymerizable organic monomer segment A2 which is connected to the polymerizable monomer segment A1 via a covalent chemical bond, under polymerization conditions under which both the polymerizable monomer segment A1 and the polymerizable organic monomer segment A2 polymerize with breakage of the covalent chemical bond between A1 and A2.

21. The process according to claim 20, which is a process for gas separation.

22. The process according to claim 20, which is a process for pervaporation.

23. The process according to claim 20, wherein the monomers to be polymerized comprise a first monomer M1 and at least one second monomer M2, the monomers M2 differing from the monomer M1 at least in one of the monomer segments A1 and A2, or the monomers to be polymerized, as well as the at least one monomer to be polymerized, comprising at least one further, different monomer which has no monomer segment A1 and is copolymerizable with the monomer segment A2.

24. The process according to claim 20, wherein the metal or semimetal M of the monomer segment A1 is B, Al, Si, Ti, Zr, Hf, Ge, Sn, Pb, V, As, Sb, Bi or a mixture thereof.

25. The process according to claim 20, wherein the metal or semimetal M of the monomer segment A1 comprises silicon to an extent of at least 90 mol %, based on the total amount of M.

26. The process according to claim 20, wherein the monomers to be polymerized, which have at least one monomer segment A1 and at least one monomer segment A2, comprise a first monomer M1 and at least one second monomer M2 which differs from the monomer M1 at least in the monomer segment A1.

27. The process according to claim 20, wherein the monomers which have at least one monomer segment A1 and at least one monomer segment A2 are described by the formula 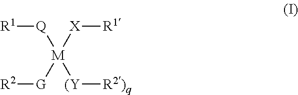
in which
M is a metal or semimetal;
R¹ and R² are the same or different and are each an Ar—C(R^{a},R^{b})— radical in which Ar is an aromatic or heteroaromatic ring which optionally has 1 or 2 substituents selected from halogen, CN, C₁-C₆-alkyl, C₁-C₆-alkoxy and phenyl, and R^{a}, R^{b} are each independently hydrogen or methyl or together are an oxygen atom, or the R¹Q and R²G radicals are each a radical of the formula A 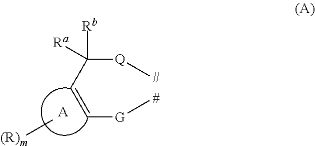
in which A is an aromatic or heteroaromatic ring fused to the double bond, m is 0, 1 or 2, R is the same or different and is selected from the group consisting of halogen, CN, C₁-C₆-alkyl, C₁-C₆-alkoxy and phenyl, and R^{a} and R^{b} are each as defined above;
G is O, S or NH;
Q is O, S or NH;
q according to the valency of M is 0, 1 or 2,
X and Y are the same or different and are each O, S, NH or a chemical bond;
R^{1′} and R^{2′} are the same or different and are each C₁-C₆-alkyl, C₃-C₆-cycloalkyl, aryl or an Ar′—C(R^{a′},R^{b′})— radical in which Ar′ is as defined for Ar and R^{a′}, R^{b′} are each as defined for R^{a}, R^{b}, or R^{1′}, R^{2′} together with X and Y are a radical of the formula A, as defined above.

28. The process according to claim 20, wherein the monomers to be polymerized, which have at least one monomer segment A1 and at least one monomer segment A2, comprise at least one monomer of the general formula II: 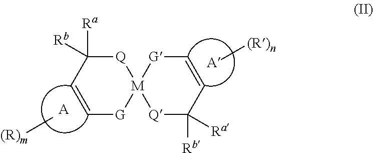
in which
M is a metal or semimetal;
A and A′ are each an aromatic or heteroaromatic ring fused to the double bond;
m and n are each independently 0, 1 or 2;
G and G′ are the same or different and are each independently O, S or NH;
Q and Q′ are the same or different and are each independently O, S or NH;
R and R′ are the same or different and are each independently selected from the group consisting of halogen, CN, C₁-C₆-alkyl, C₁-C₆-alkoxy and phenyl; and
R^{a}, R^{b}, R^{a′} and R^{b′} are each independently hydrogen or methyl, or
R^{a} and R^{b} and/or R^{a′} and R^{b′} in each case together are an oxygen atom.

29. The process according to claim 20, wherein the monomers to be polymerized, which have at least one monomer segment A1 and at least one monomer segment A2, comprise a first monomer M1 and at least one second monomer M2 which differs from the monomer M1 at least in one of the monomer segments A1, the monomer M1 being selected from the monomers of the formula II and the at least one further monomer M2 being selected from the monomers of the formula III: 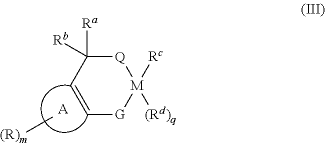
in which
M is a metal or semimetal;
A is an aromatic or heteroaromatic ring fused to the double bond;
m is 0, 1 or 2;
G is O, S or NH;
Q is O, S or NH;
R is independently a halogen, CN, C₁-C₆-alkyl, C₁-C₆-alkoxy or phenyl;
R^{a} and R^{b} are each independently hydrogen or methyl, or R^{a} and R^{b} together are an oxygen atom, and
R^{c} and R^{d} are the same or different and are C₁-C₆-alkyl, C₃-C₆-cycloalkyl or aryl.

30. The process according to claim 28, wherein the monomers to be polymerized, which have at least one monomer segment A1 and at least one monomer segment A2, comprise a first monomer M1 and at least one second monomer M2 which differs from the monomer M1 in the monomer segments A2 and optionally A1, the monomer M1 being selected from the monomers of the formula II and the at least one further monomer M2 being selected from the monomers of the formula IV: 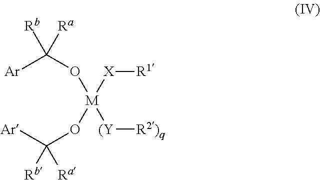
in which:
M is a metal or semimetal;
Ar and Ar′ are the same or different and are each an aromatic or heteroaromatic ring which optionally has 1 or 2 substituents selected from the group consisting of halogen, CN, C₁-C₆-alkyl, C₁-C₆-alkoxy and phenyl;
R^{a}, R^{b}, R^{a′} and R^{b′} are each independently hydrogen or methyl, or
R^{a} and R^{b} and/or R^{a′} and R^{b′} in each case together are an oxygen atom;
q according to the valency of M is 0, 1 or 2;
X and Y are the same or different and are each O, S, NH or a chemical bond; and
R^{1′} and R^{2′} the same or different and are each C₁-C₆-alkyl, C₃-C₆-cycloalkyl, aryl or an Ar″—C(R^{a″},R^{b″})— radical in which Ar′ is as defined for Ar and R^{a″}, R^{b″} are each as defined for R^{a}, R^{b}, or R^{1′}, R^{2′} together with X and Y are a radical of the formula A as defined above.

31. The process according to claim 20, wherein the monomers to be polymerized, which have at least one monomer segment A1 and at least one monomer segment A2, comprise at least one monomer of the general formula V: 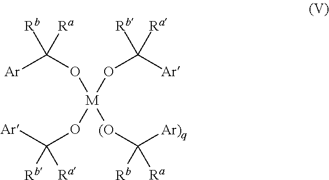
in which
M is a metal or semimetal;
Ar and Ar′ are the same or different and are each an aromatic or heteroaromatic ring which optionally has 1 or 2 substituents selected from the group consisting of halogen, CN, C₁-C₆-alkyl, C₁-C₆-alkoxy and phenyl;
R^{a}, R^{b}, R^{a′} and R^{b′} are each independently hydrogen or methyl, or
R^{a} and R^{b} and/or R^{a′} and R^{b′} in each case together are an oxygen atom; and
q according to the valency of M is 0, 1 or 2.

32. The process according to claim 31, wherein the monomers to be polymerized, which have at least one monomer segment A1 and at least one monomer segment A2, comprise a first monomer M1 and at least one second monomer M2 which differs from the monomer M1 at least in the monomer segment A1, the monomer M1 being selected from a monomer of the formula V and the at least one further monomer M2 being selected from the monomers of the formula V which differ from the monomer M1 in the (semi)metal M.

33. The process according to claim 31, wherein the monomers to be polymerized, which have at least one monomer segment A1 and at least one monomer segment A2, comprise a first monomer M1 and at least one second monomer M2 which differs from the monomer M1 in the monomer segments A1 and A2, the monomer M1 being selected from the monomers of the formula V and the at least one further monomer M2 being selected from the monomers of the formula III as defined in claim 31.

34. The process according to claim 31, wherein the monomers to be polymerized, which have at least one monomer segment A1 and at least one monomer segment A2, comprise a first monomer M1 and at least one second monomer M2 which differs from the monomer M1 at least in the monomer segment A1, the monomer M1 being selected from the monomers of the formula V and the at least one further monomer M2 being selected from the monomers of the formula VI: 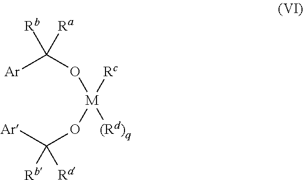
in which
M is a metal or semimetal;
Ar and Ar′ are the same or different and are each an aromatic or heteroaromatic ring which optionally has 1 or 2 substituents selected from the group consisting of halogen, CN, C₁-C₆-alkyl, C₁-C₆-alkoxy and phenyl;
R^{a}, R^{b}, R^{a′} and R^{b′} are each independently hydrogen or methyl, or
R^{a} and R^{b} and/or R^{a′} and R^{b′} in each case together are an oxygen atom;
q according to the valency of M is 0, 1 or 2; and
R^{c} and R^{d} are the same or different and are each selected from C₁-C₆-alkyl, C₃-C₆-cycloalkyl and aryl.

35. The process according to claim 20, wherein the polymerization is initiated by an initiator I which is selected from the group consisting of Lewis acids and Brønsted acids.

36. The process according to claim 20, comprising
(b) reacting the monomers M1 and optionally M2 in the presence of the initiator I and optionally of the solvent (L) to give a prepolymer;
(d) applying the mixture from step (b) to a surface; and
(e) converting the prepolymer to a polymer film.

37. The process according to claim 36, comprising
(a) providing the monomers M1 and optionally M2, an initiator I and optionally a solvent (L);
(b) reacting the monomers M1 and optionally M2 in the presence of the initiator I and optionally of the solvent (L) to give a prepolymer;
(c) mixing the resulting prepolymer with a solvent (L*);
(d) applying the mixture from step (c) to a surface; and
(e) converting the prepolymer to a polymer film.

38. The process according to claim 20, which is a process for permeation.
